(19) United States
(12) Patent Application Publication
(10) Pub. No.: US 2025/0367944 A1
(43) Pub. Date: Dec. 4, 2025

(54) MEDIA EDGE CURL PREVENTER FOR A SCANNING INKJET PRINTER HAVING AN ENDLESS SUCTION TRANSPORT BELT

(71) Applicant: CANON KABUSHIKI KAISHA, Tokyo (JP)

(72) Inventor: Marcus H.G.W. HEES, Echt (NL)

(21) Appl. No.: 19/224,172

(22) Filed: May 30, 2025

(30) Foreign Application Priority Data
May 31, 2024 (EP) 24179290.2

(51) Int. Cl. B41J 11/00; B41J 15/04; B41J 15/16

(52) U.S. Cl. CPC B41J 11/0005; B41J 11/007; B41J 11/0085; B41J 15/048; B41J 15/16

(57) ABSTRACT

A solution is provided to prevent the lateral side edges of print media on an endless suction transport belt from colliding with the scanning print head carriage. The printer includes a media edge curl preventer having a hold-down body positionable so that the hold-down body curves towards the medium support surface. The printer also includes a curvature adjuster configured to adjust a curvature of the hold-down body, thereby adjusting a hold down force the hold-down body exerts towards the medium support surface.

### CROSS-REFERENCE TO RELATED APPLICATIONS

This application claims the benefit of European Patent Application No. 24179290.2 filed on May 31, 2024, which is incorporated by reference herein in its entirety.

### BACKGROUND OF THE INVENTION

### Field of the Invention

The disclosure relates to a media edge curl preventer for a printer, a printer including such a media edge curl preventer, and to a method of printing.

### Description of Background Art

US2018093497 A2 discloses a media edge curl preventer for a printer comprising a stationary medium support surface for supporting a print medium in the form of a platen. The medium support surface faces a printing assembly. The media edge curl preventer generally comprises an edge restrictor in the form of a plate or sheet over the medium support surface. The edge restrictor is spaced at a distance from the medium support surface by a spacer and is positioned in the horizontal plane, so that the edge restrictor will be over an edge of the print medium when the print medium is in the print zone of the medium support surface below the printing assembly. In US2018093497 A2, a base of the media edge curl preventer is mounted on a stationary medium support surface, while its edge restrictor is at a distance from said medium support surface. The edge curl preventer is mounted on the stationary medium support surface besides the print medium. It is further known that a printer may be provided with an endless transport which forms the medium the support surface.

### SUMMARY OF THE INVENTION

The present disclosure provides an improved media edge curl preventer, preferably a versatile media edge curl preventer suitable for a wide range of print media, and even more preferably a media edge curl preventer suitable for use in a scanning inkjet printer including an endless transport belt.

The present disclosure is directed to a method of loading a web of print medium in a media edge curl preventer, a printer, and a method.

The media edge curl preventer is configured for use in a printer including a medium support surface for supporting a print medium and facing a printing assembly. The media edge curl preventer further includes:
a hold-down body configured to hold down an edge of the print medium extending in a longitudinal direction and positionable, so that the hold-down body curves towards the medium support surface; and
a curvature adjuster configured for adjusting a curvature of the hold-down body, thereby adjusting a hold-down force the hold-down body exerts towards the medium support surface.

In an embodiment, the medium support surface is configured for holding the print medium. The medium support surface may include holding means for forcing the print medium against the medium support surface. The holding means may include for example suction or vacuum devices, which apply a negative pressure to a side of the print medium facing the medium support surface. Other holdings means such as pressing means or electrostatic holding means may also be applied. In an embodiment, the medium support surface is defined by an endless belt. The belt is preferably provided with openings via which a negative pressure can be applied to the print medium.

It is the insight of the inventor that an adjustable hold-down force allows a media edge curl preventer to adjust to different print media. It is the further insight of the inventor that the hold-down force can be adjusted by adjusting the curvature of a hold-down body curving onto the medium support surface. The hold-down body when in use exerts a force on a side edge of the print medium. The curvature of the hold-down body, for example in the form of a strip, can be adjusted by means of the curvature adjuster. When mounted on the printer, a portion of the hold-down body is supported on the print medium's edge and/or the medium support surface, while another portion is held by the curvature adjuster. By adjusting the curvature of the hold-down body, the force it exerts on the print medium can be increased or decreased. Thereby, the hold-down force can be selected in correspondence with the applied media type. More resilient or stiffer print media can be provided with a greater hold-down force, as to ensure these media do not displace the hold-down body. For weaker print media, lower forces can be applied. The curvature adjuster can be mounted on the frame of a printer away from the printing assembly, while the hold-down body can extend underneath the printing assembly in slidable contact with the media support surface. This allows the media edge curl preventer to be applied in a scanning inkjet printer with an endless transport belt. Thereby, the object of the present disclosure has been achieved.

More specific optional features of the disclosure are indicated in the dependent claims.

In an embodiment, the hold-down body is longitudinal. The hold-down body has a relatively great length in the longitudinal direction as compared to its width and height. The direction of the hold-down body preferably defines the longitudinal direction. In practice this often coincides with the direction of a lateral edge of a rectangular print medium. In case the print medium moves during the printing process, the longitudinal direction is preferably parallel to a transport direction of the print medium.

In an embodiment, during use the hold-down body extends between a curvature adjuster and a contact point where the hold-down body contacts the print medium and/or the medium support surface. The contact point is preferably between the medium support and the printing assembly, so that the edges of the print medium are held flat below the printing assembly. The curvature adjuster is preferably arranged to adjust the curvature of the portion of the edge-hold down body between the contact point and the curvature adjuster.

In an embodiment, the hold-down body includes a spacer and an edge restrictor positioned at a predetermined distance from the medium support surface by the spacer, when the spacer is in contact with the print medium support surface, and wherein the edge restrictor extends beyond the spacer in a direction parallel to the medium support surface. The hold-down body includes a step shape, which step is in the lateral direction of the belt. The edge restrictor is more remote from the medium support surface than the spacer, so that a recess is formed underneath it, wherein the edge of the print medium can be inserted. The step may act as a guide for positioning the hold-down body at an edge of a print medium. The spacer may further directly contact the belt, so that the edge restrictor is over and away from the medium support surface. The edge restrictor may be formed by a plate or strip. In an embodiment, the spacer is formed as a strip upon which a strip forming the edge restrictor has been mounted.

In an embodiment, the spacer and/or the edge restrictor includes a smooth contact surface configured for sliding contact with the belt and/or the print medium. When the belt moves, the hold-down body remains stationary. The print medium slides with little friction along the edge restrictor to ensure controlled movement. The belt may slide along a smooth portion of the spacer, when in contact. Thes contact surfaces are sufficiently smooth to allow sliding movement regardless of the hold-down force driving the edge restrictor towards the belt.

In an embodiment, the hold-down body is formed as an elastic strip. When adjusting the curvature of the strip, the elasticity creates a force seeking to return the strip to a tension-free state. The curvature of the strip converts this elastic force into a downward force, which presses the strip towards and onto the print medium and/or the medium support surface. The downward force can thus be set or adjusted by means of the curvature of the strip. It will be appreciated that the strip herein is defined as a longitudinal, narrow body. As indicated above, the body may have a step shape and/or be formed by multiple strips adhered to one another.

In an embodiment, the media edge curl preventer further includes a gripper for holding a portion of the hold-down body and an actuator for moving the gripper with respect to the medium support surface, so that the curvature of the hold-down body between the gripper and a print zone defined by the printing assembly changes. The gripper engages the hold-down body preferably remote of the print zone, for example near an end of the hold-down body. The position of the gripper can be adjusted and set or fixed with respect to the medium support surface, thereby adjusting the curvature of the hold-down body. Preferably, the gripper is positioned near an edge of the medium support surface, where it is easily accessible. Moving the gripping away from the medium support surface preferably increases the tension in the hold-down body, while moving it towards the medium support surface decreases the tension, or vice versa.

In an embodiment, the media edge curl preventer includes at least two pairs of the curvature adjuster and the hold-down body, wherein the at least two curvature adjusters are movably mounted on a support beam. Two curvature adjusters and two edge hold-down bodies are mounted together on a common support beam, so that opposite side edge of a single print medium can be held down. The positions of said pairs on the support are preferably adjustable in accordance with the dimensions of the print medium. In case multiple print media are positioned together on the medium support surface, multiple of said pairs may be provided on the support beam. Preferably, the curvature adjuster is slidably mounted on the support beam and includes locking means for securing their positions on the support beam.

In an embodiment, the gripper is configured to bend the hold-down body into a minimum or near-zero curvature. When the hold-down body is substantially straight or minimally curved, it exerts a small force on the medium support surface. In this state, the hold-down body can be easily moved over the medium support surface. This allows the hold-down body to be easily set for different media sizes.

In an embodiment, a curvature adjuster is configured to bend the hold-down body, so that the hold-down body is elastically tensioned between the hold-down body and the print medium and/or the medium support surface, so that the hold-down body presses locally onto the print medium and/or the medium support surface. The curvature adjuster is arranged to adjust the position of the gripper with respect to the medium support surface.

The hold-down body presses against the print medium and/or the medium support surface. By adjusting the position of the gripper, the curvature of the hold-down body between the contact point with the print medium and/or the medium support surface and the gripper can be changed. In case of an elastic hold-down body, the elasticity of the hold-down body works against an increase in curvature, resulting in a greater downward force on the medium support surface.

In an embodiment, the hold-down body is bendable so that it contacts the print medium and/or the medium support surface facing the printing assembly without directly contacting the printing assembly. The hold-down body is bent so that it curves around the printing assembly. In case the printing assembly includes a scanning carriage, the hold-down body is curved out of the path of the carriage and also away from a beam supporting the carriage.

The present disclosure further relates to a printer includes the media edge curl preventer as described in any of the above embodiment. The printer further includes the printing assembly with an inkjet printhead carriage translatable along a gantry over the medium support surface. The printer is a scanning inkjet printer.

In an embodiment, the medium support surface is formed by an endless transport belt extending over a suction chamber and movable in a transport direction perpendicular a scanning direction of the printhead carriage. The belt is air permeable, so that print media can be held against by means of a negative pressure applied in the suction chamber. The belt preferably forms the entire media support surface, at least in the print zone.

The present disclosure further relates to a method for printing on a print medium, includes the steps of: selecting a print medium; curving an hold-down body into a predetermined curvature in correspondence to the selected print medium, so that a portion of the hold-down body presses onto the print medium and/or a medium support surface facing a printing assembly; transporting a print medium on the medium support surface, so that at least one of its edges is forced under the hold-down body.

The method can be performed on any of the above-described embodiments.

Further scope of applicability of the present disclosure will become apparent from the detailed description given hereinafter. However, it should be understood that the detailed description and specific examples, while indicating embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure, and wherein:

FIG. 1 is a schematic perspective view of a printing system according to the present disclosure in a first printing mode;

FIG. 2 is a schematic perspective view of a printing system in FIG. 1 in a second printing mode;

FIG. 3 is a schematic cross-sectional side view of the printing system in FIG. 1 with the hold-down body having a first radius of curvature;

FIG. 4 is a schematic cross-sectional side view of the printing system in FIG. 1 with the hold-down body having a second radius of curvature;

FIG. 5 is a schematic cross-sectional side view of the printing system in FIG. 1 with the hold-down body having a third radius of curvature; and

FIG. 6 is a schematic cross-sectional side view of the printing system in FIG. 1 with another embodiment of a hold-down body;

FIG. 7 is an enlarged schematic cross-sectional side view at an edge of a relatively thin print medium under the hold-down body;

FIG. 8 is an enlarged schematic cross-sectional side view at an edge of a relatively thick print medium under the hold-down body;

FIG. 9 is a schematic top view of an edge of a hold-down body in a first position not covering a print medium; and

FIG. 10 is a schematic top view of the edge of a hold-down body in FIG. 9 shifted to a second position over the print medium.

### DETAILED DESCRIPTION OF THE EMBODIMENTS

The present disclosure will now be described with reference to the accompanying drawings, wherein the same reference numerals have been used to identify the same or similar elements throughout the several views.

### Printing System

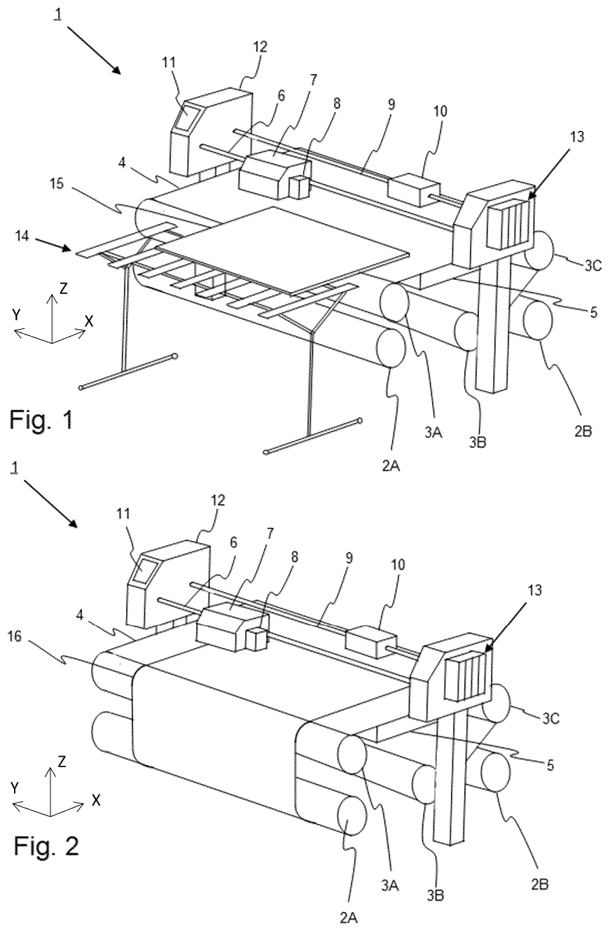

FIG. 1 shows a wide format inkjet printer 1. The wide-format printer 1 includes an inkjet printing assembly 7 for printing on a print medium 15. The print medium 15 in FIG. 1 is a relatively rigid substrate, such as a panel. The print medium 15 is supplied from a media input unit 14, which may be configured for storing a plurality of such print media 15 and supplying these to the printer 1. The printer 1 includes transport means for receiving and transporting the print medium 15 along the inkjet printing assembly 7. In FIG. 1, the transport means includes an endless transport belt 4 supported on a plurality of support rollers 3A, 3B, 3C. At least one of the support rollers 3A, 3B, 3C is provided with driving means for moving the belt 4. Additionally, one or more of the support rollers 3A, 3B, 3C may be configured to be moved and/or tilted to adjust and control the lateral position of the belt 4. The inkjet printing assembly 7 may be provided with a sensor 8, such as a CCD camera, to determine the relative position of the belt 4 and/or the print medium 15. Data from said sensor 8 may be applied to control the position of the belt 4 and/or the print medium 15. The belt 4 is further provided with through-holes and a suction box 5 in connection with a suction source (not shown), such that a negative pressure may be applied to the print medium 15 via the through-holes in the belt 4. The negative pressure adheres the print medium 15 flatly to the belt 4 and prevents displacement of the print medium 15 with respect to the belt 4. Due to this holding, the belt 4 is able to transport the print medium 15. It will be appreciated that other suitable transport means, such as rollers, steppers, etc., may alternatively be applied. The print medium 15 may be transported stepwise and/or in continuous movement.

The inkjet printing assembly 7 is configured to translate along a first guide beam 6 in a scanning direction. The scanning direction is perpendicular to the direction in which the print medium is transported by the belt 4. The inkjet printing assembly 7 holds a plurality of print heads (not shown), which are configured to jet a plurality of different marking materials (different colors of ink, primers, coatings, etc.) on the print medium 15. Each marking material for use in the printing assembly 7 is stored in one of a plurality of containers arranged in fluid connection with the respective print heads for supplying marking material to said print heads to print an image on the print medium 15.

The ejection of the marking material from the print heads is performed in accordance with data provided in the respective print job. The timing by which the droplets of marking material are released from the print heads determines their position on the print medium 15. The timing may be adjusted based on the position of the inkjet printing assembly 7 along the first guide beam 6. The above-mentioned sensor 8 may therein be applied to determine the relative position and/or velocity of the inkjet printing assembly 7 with respect to the print medium 15. Based upon data from the sensor 8, the release timing of the marking material may be adjusted.

Upon ejection of the marking material, some marking material may be spilled and stay on a nozzle surface of the print heads. The marking material present on the nozzle surface may negatively influence the ejection of droplets and the placement of these droplets on the print medium 15. Therefore, it may be advantageous to remove excess marking material from the nozzle surface. The excess marking material may be removed for example by wiping with a wiper and/or by application of a suitable anti-wetting property to the surface, e.g. provided by a coating.

The marking materials may require treatment to properly fixate them on the print medium. Thereto, a fixation unit 10 is provided downstream of the inkjet printing assembly 7. The fixation unit 10 may emit heat and/or radiation to facilitate the marking material fixation process. In the example of FIG. 1, the fixation unit 10 is a radiation emitter, which emits light of certain frequencies, which interacts with the marking materials, for example UV light in case of UV-curable inks. The fixation unit 10 in FIG. 1 is translatable along a second guide beam 9. Other fixation units 10, such as page-wide curing or drying stations may also be applied. Further, the inkjet printing assembly 7 may be provided with a further fixation unit on the same carriage that holds the print heads. This further fixation unit can be used to (partially) cure and/or harden the marking materials, independent of or interaction with the fixation unit 10.

After printing, and optionally fixation, the print medium 15 is transported to a receiving unit (not shown). The receiving unit may include a take-up roller for winding up the print medium 15, a receiving tray for supporting sheets of print medium 15, or a rigid media handler, similar to the media input unit 14. Optionally, the receiving unit may include processing means for processing the medium 8, 9 after printing, e.g. a post-treatment device such as a coater, a folder, a cutter, or a puncher.

The wide-format printer 1 furthermore includes a user interface 11 for receiving print jobs and optionally for manipulating print jobs. The local user interface unit 11 is integrated to the print engine and may include a display unit and a control panel. Alternatively, the control panel may be integrated in the display unit, for example in the form of a touch-screen control panel. The local user interface unit 11 is connected to a control unit 12 connected to the printer 1. The control unit 12, for example a computer, includes a processor adapted to issue commands to the printer 1, for example for controlling the print process. The printer 1 may optionally be connected to a network. The connection to the network can be via cable or wireless. The printer 1 may receive printing jobs via the network. Further, optionally, the control unit 12 of the printer 1 may be provided with an input port, such as a USB port, so printing jobs may be sent to the printer 1 via this input port.

### Hybrid Printing System

The printer 1 in FIG. 1 is a so-called hybrid printer, capable of handling both flexible media and rigid substrates. In FIG. 1, the printer 1 operates in a first print mode, wherein the printer 1 is configured for transporting rigid substrates, such as the print medium 15. Such rigid print media 15 may be panels for doors, walls, etc., corrugated media, plates formed of plastic or metal, etc. To handle these rigid print media 15, the printer 1 in FIG. 1 is configured with a substantially linear transport path: from the media input device 14, the print medium 15 moves forward along the inkjet printing assembly 7 at a substantially constant height. The media input unit 14 and the receiving unit are positioned at the level of the medium support surface of the belt 4. In FIG. 2, a flexible web medium 16 is supplied to the printer 1, which web medium 16 may be composed of e.g. paper, label stock, coated paper, plastic or textile. The web medium 16 is supplied from the input roller 2A and extends across the belt 4 to the take-up roller 2B, where the web medium 16 is re-wound. The printer 1 is configured to swiftly and efficiently switch between print modes.

### Media Side Edge Curl Prevention

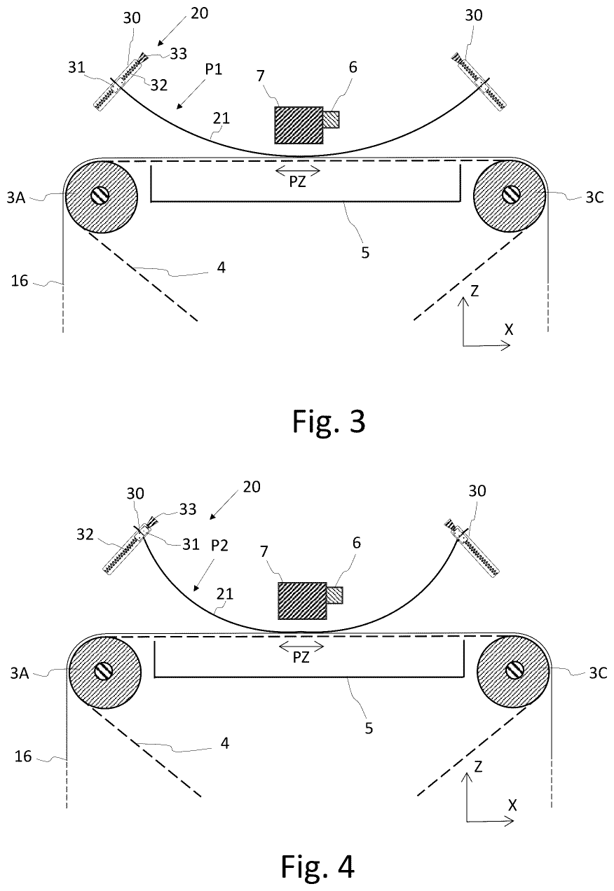

FIG. 3 illustrates the printer in FIG. 2 provided with a media edge curl preventer 20. While on the transport belt 4, print media 15, 16 are sucked against the belt 4 by means of the negative pressure applied in the suction chamber 5. At the lateral side edges of the print media 15, 16, the negative pressure is negatively affected by air flowing into uncovered portions of the belt 4, locally reducing the holding force. This force may under certain circumstances become insufficient to prevent the edge of certain print media 15, 16 from curling upwards away from the belt 4. The edges of the print media 15, 16 may then come into contact with the printheads on the scanning printing assembly 7. This may result in damage to the print media 15, 16 and/or the printheads. The media edge curl preventer 20 prevents the side edges of the print media 15, 16 from curling more than a predetermined distance away from the belt 4 in the vertical direction Z.

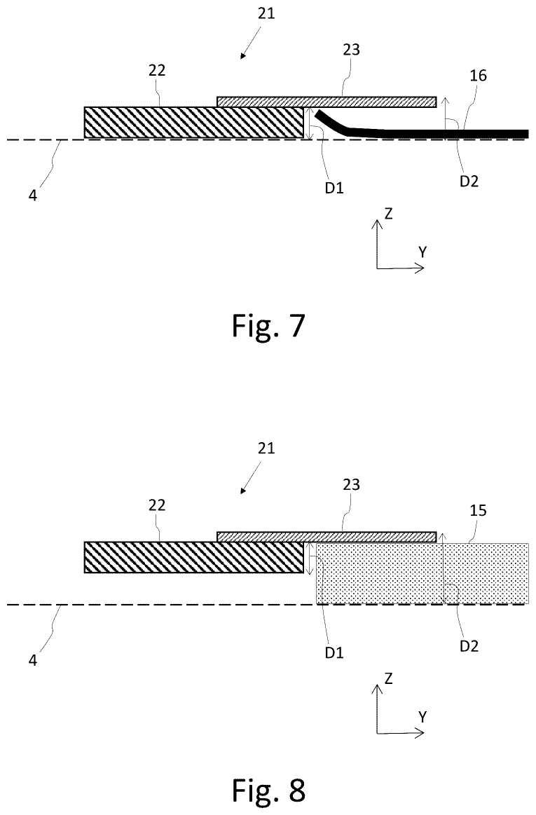

The media edge curl preventer 20 includes a bendable hold-down body 21, which extends from the upstream of the printing assembly 7 to between the printing assembly 7 and the belt 4 in the print zone PZ. Below the printing assembly 7, the hold-down body 21 contacts the belt 4 or the print medium 15, 16 at a contact point. Preferably, the hold-down body 21 is positioned at each lateral side edge of a print medium 15, 16 on the belt 4: what is illustrated in FIG. 7 is mirror symmetrically provided on the opposite edge of the print medium 15, 16. As shown in FIG. 7, the hold-down body 21 includes a spacer 22, which is in direct contact with the belt 4, or as illustrated in FIG. 8 above the belt 4. The spacer 22 may be in the form of a block, or any other suitable distancing means. The spacer 22, when in place on the belt 4 as in FIG. 7, positions an edge restrictor 23 at a predetermined distance D1 from the top surface of the belt 4. The edge restrictor 23 extends beyond or protrudes from the spacer 22 in the lateral direction Y, so that a recess is formed between the belt 4 and the edge restrictor 23. The recess is open in the lateral direction Y and an edge of a print medium 16 is received therein. Due to the edge restrictor 23 overhanging the edge of the print medium 16, the edge of the print medium 16 is prevented from curling away from the belt 4 by more than the distance D1. The edge restrictor 23 is formed of a plate mounted onto the spacer 22. The total or maximum height D2 of the hold-down body 21 in the print zone PZ with respect to the belt 4 below the printing assembly 7 is less than the print gap between the printing assembly 7 and the belt 4, so that the scanning printhead carriage passes over the hold-down body 21 while scanning. As illustrated in FIG. 8, the hold-down body 21 does not directly contact the belt 4 when the height or thickness of the print medium 15 exceeds the height D1 of the spacer 22. The print medium 15 lifts the edge restrictor 23, so that the spacer 22 is above the belt 4. The step form in the hold-down body 21 aids the operator in to easily positioning it at the edge of the print medium 15.

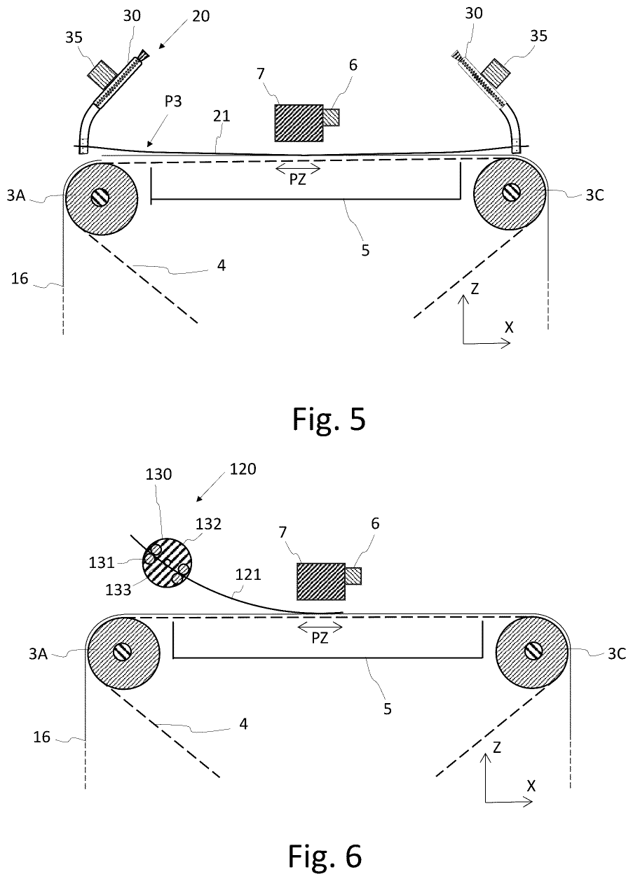

The hold-down body 21 in FIG. 3 curves downward from the upstream side of the belt 4 downwards to underneath the printing assembly 7. The curvature of the hold-down body 21 can be adjusted, allowing it to change its radius of curvature. Thereto, the hold-down body 21 is formed of a bendable material, preferably an elastically bendable material, for example metal, such as steel or iron. Alternatively, the hold-down body 21 may be formed of plastics or composite materials. The curvature of the hold-down body 21 is adjustable by means of the at least one curvature adjuster 30. By adjusting the curvature of the hold-down body 21, the force it exerts on the belt 4 and/or the print medium 15, 16 in the print zone PZ can be increased or decreased, dependent on the media type. The curvature adjuster 30 includes a gripper 32 that grips and holds the hold-down body 21 at or near its end. This end faces away from the printing assembly 7. An actuator 32 is provided to adjust the position of the gripper 32, so that the position of the gripped end or portion of the hold-down body 21 with respect to the print zone PZ can be changed. Preferably, the contact point where the hold-down body 21 contacts the print medium 15, 16 or the belt 4 is relatively and/or substantially stationary. By means of the applicator 33, the operator may control the actuator 32 to adjust the position of the gripper 31. The actuator 32 in FIG. 3 is in the form of a screw or bolt system. By rotating the applicator 33 in the form of a handle, the screw is rotated with respect to the gripper 31, causing the gripper 31 to move upward or downward. Upward motion in FIG. 3 results in an increase of the force the hold-down body 21 exerts on the belt 4 and the print medium 15, 16. Downward motion increases the radius of curvature of the hold-down body 21, thereby decreasing the force it exerts on the belt 4. The curvature adjuster 30 is preferably rigidly connected to the frame of the printer, which frame also supports the gantry 6. The curvature adjuster 30 is remote from the gantry 6. Preferably, a curvature adjuster 30 is provided for every one of the plurality of the edge hold-down bodies 21 on the printer 1. The curvature adjusters 30 are then preferably mounted on a common support beam (35 in FIG. 5). It will be appreciated that the support beam 35 is mounted to the printer, so that it does interfere with the movement of the print media 15, 16 and/or the belt 4. In FIG. 3, a curvature adjuster 30 is also provided at the downstream side of the hold-down body 21, though it will be appreciated that this curvature adjuster 30 may configured differently and/or omitted. The downstream end of the hold-down body 21 may be free or fixed to the frame of the printer. It will further be appreciated that different actuators may be applied as, such as a force actuator and/or a positional actuator, for example in the form of springs, rack and pinion mechanisms, bolt and nut assemblies, linear drives, pulleys, motors, etc. When applying multiple hold-down bodies 21, the curvature adjusters 30 can preferably be controlled independently, allowing the curvature of each hold-down body 21 to set independently or different from the other. When multiple print media 15, 16 are on the belt 4 at once, the hold-down force may set for each print medium 15, 16 individually. Additionally, it is noted that the hold-down body 21 and/or the curvature adjuster 30 can further be positioned vertically and/or perpendicular to the print medium support surface. This allows the height of the hold-down body 21 to be set in corresponding to a thickness of a print medium. When simultaneously applying multiple hold-down bodies to multiple print media 15, 16 of different thicknesses, each curvature adjuster 30 can be set so that the same or a similar hold down force is applied to all the different print medium 15, 16, even when the different print media 15, 16 have different thicknesses. Different curvatures may be applied to different hold-down bodies 21 on media of different thicknesses to achieve the same or a similar hold-down force.

FIG. 3 illustrates the hold-down body 21 in a first position P1 with a first radius of curvature. The position P1 is intended to apply a moderate hold-down force by means of the hold-down body 21. The hold-down body 21 is prevented from being moved further downward in the print zone PZ by the belt 4. The gripper 31 of the curvature adjuster 30 is positioned higher than the belt 4, curving the hold-down body 21 away from the belt 4 towards the upstream side of the belt 4. Due to its elasticity, the hold-down body 21 acts as a spring, which is constantly urging to return to its rest position. This results in a hold-down force pressing the hold-down body 21 in the print zone PZ securely onto the belt 4 or the print medium 15, 16. Print media 15, 16, as shown in FIG. 7, are then transported by the belt 4, so that their edges slide underneath the respective edge restrictors 23. Due to the gradual curvature of the hold-down body 21, the edges of the print medium 15,16 move smoothly underneath the hold-down body. In case the edges curl up, the edges may exert an upward force on the edge restrictor 23. The curvature of the hold-down body 21 has however been selected, so that the hold-down force urging the hold-down body 21 towards the belt 4 in the print zone PZ is greater than any force the print media 15, 16 may exert. In the first position P1, the hold-down body 21 is suited for holding down e.g. web based print media 16 provided in roll form. The hold-down body 21 is preferably longitudinal in the transport direction, e.g. in the form of a strip. Where the hold-down body 21 contacts the belt 4 or the print medium 15, 16, the hold-down body is smooth to ensure low friction contact, which allows the belt 4 to slide along the hold-down body.

More rigid print media 15, such as cardboard or panels, may exert greater forces on the hold-down body 21 in case of wrinkles at their edges. These print media 15 may also be relatively thick, preventing the hold-down body from contacting the belt 4, as shown in FIG. 8. In FIG. 4, the curvature adjuster 30 has been controlled, so that its gripper 31 has moved the gripped portion of the curvature adjuster 30 further away from the belt 4 into the second position P2. Thereby, the curvature adjuster 30 has become more bent as compared to the first position P1 in FIG. 3: the radius of the curvature of the curvature adjuster 30 in FIG. 4 is smaller than that in FIG. 3, resulting in a greater downward force in the print zone PZ.

FIG. 5 illustrates the curvature adjuster 30 having been moved into a third position, wherein the radius of curvature of the hold-down body 21 is relatively large, so that it is substantially not bent or minimally curved. In the position P3, the vertical force of the curvature adjuster 30 on the belt 4 is very small. This allows the curvature adjuster 30 to be moved laterally over the belt 4, so that it can be aligned with the edges of a new print medium 15, 16. The curvature adjusters 30 are thereto provided slidably on the support beam 35, for example by means of a translational or sliding bearing. This allows the edge hold-down bodies 21 to be easily set at the intended lateral positions. In the third position P3, the gripper 31 may even be released from the actuator 32, as no bending force is required.

FIG. 6 illustrates another embodiment of the hold-down body 121, which extends from the upstream curvature 130 adjuster only up to the print zone PZ. The downstream end of the hold-down body 121 in FIG. 6 is a free end, which may optionally even be positioned beyond the printing assembly 7. The curvature adjuster 130 in FIG. 6 includes a rotational gripper 131, which grips the hold-down body 121 at two points spaced apart in the transport direction X. The gripper 131 is provided on a rotational actuator 132. By rotating the actuator 132 around its axis 133, the curvature of the hold-down body 121 can be adjusted. It will be appreciated that the curvature adjuster 130 adjusts the curvature of the portion of the edge hold-down-body 121 between the curvature adjuster 130 and the print zone PZ. To control the curvature of that portion, the portion engaged by the gripper 131 or upstream thereof may be curved differently and/or oppositely as compared to the curvature of the portion of the edge hold-down-body between the curvature adjuster 130 and the print zone PZ.

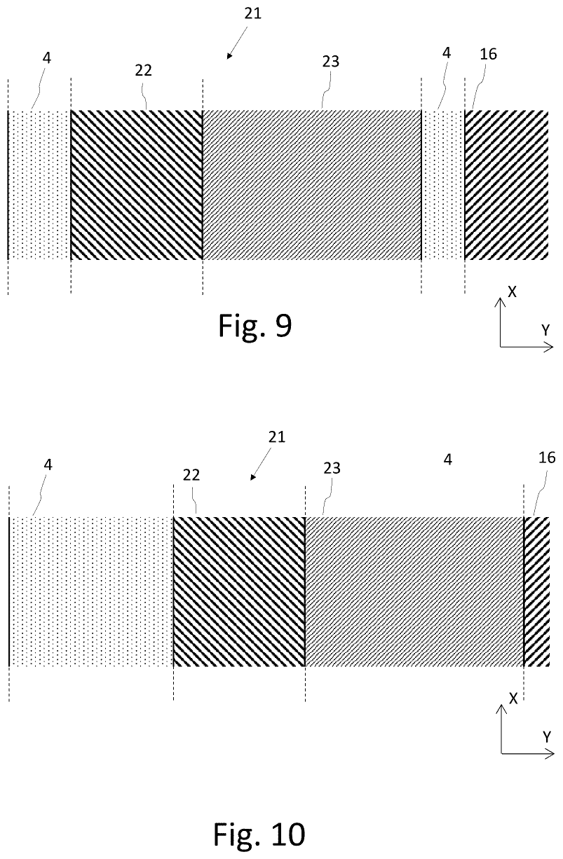

FIG. 9 illustrates a top view of the hold-down body 21. It will be appreciated that FIG. 9 shows only a section of the belt 4, the hold-down body 21, and the print medium 16. As indicated by the dashed lines, the belt 4, the hold-down body 21, and the print medium 16 extend further in the longitudinal direction X, which in FIG. 9 is parallel to the transport direction of the belt 4. In FIG. 9, a print medium 16 has been loaded onto the belt 4. The hold-down body 21 is a first lateral position, wherein it does not overlap with the print medium 16, when viewed in the vertical direction Z. Prior to the print process, the lateral position of the hold-down body 21 is adjusted by moving it in the lateral direction Y. The hold-down body 21 is laterally moved until its edge restrictor 23 overlaps the print medium 16, as shown in FIG. 10. The spacer 22 does not overlap the print medium 16 and is positioned next to it in the lateral direction Y. It will be appreciated that this lateral positioning may be performed for each lateral edge of a print medium 16 prior to printing. As explained previously, the lateral positioning may be performed by sliding the curvature adjusters 30 along their support beams 35.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

1. A media edge curl preventer for a printer comprising a medium support surface configured to support a print medium and facing a printing assembly, wherein the media edge curl preventer comprises:
a hold-down body configured to hold down an edge of the print medium, extending in a longitudinal direction, and positioned so that the hold-down body curves towards the medium support surface; and
a curvature adjuster configured to adjust a curvature of the hold-down body, thereby adjusting a hold down force the hold-down body exerts towards the medium support surface.

2. The media edge curl preventer according to claim 1, wherein the hold-down body comprises:
a spacer in contact with the print medium support surface, and
an edge restrictor positioned at a predetermined distance from the medium support surface by the spacer and extending beyond the spacer in a direction parallel to the medium support surface.

3. The media edge curl preventer according to claim 2, wherein the spacer and/or the edge restrictor comprises a smooth contact surface configured for sliding contact with the belt and/or the print medium.

4. The media edge curl preventer according to claim 1, wherein the hold-down body is formed as an elastic strip.

5. The media edge curl preventer according to claim 1, further comprising:
a gripper configured to hold a portion of the hold-down body, and
an actuator configured to move the gripper with respect to the medium support surface, so that the curvature of the hold-down body between the gripper and a print zone defined by the printing assembly changes.

6. The media edge curl preventer according to claim 5, wherein the gripper is configured to bend the hold-down body into a minimum or near-zero curvature.

7. The media edge curl preventer according to claim 1, further comprising at least two pairs of the curvature adjuster and the hold-down body, wherein the at least two curvature adjusters are movably mounted on a support beam.

8. The media edge curl preventer according to claim 4, further comprising a curvature adjuster configured to bend the hold-down body, so that the hold-down body is elastically tensioned between the hold-down body and the print medium and/or the medium support surface, so that the hold-down body presses locally onto the print medium and/or the medium support surface.

9. The media edge curl preventer according to claim 8, wherein the hold-down body is configured to bend contact the print medium and/or the medium support surface facing the printing assembly without directly contacting the printing assembly.

10. A printer comprising:
the media edge curl preventer according to claim 1; and
the printing assembly having an inkjet printhead carriage translatable along a gantry over the medium support surface.

11. The printer according to claim 10, wherein the medium support surface is formed by an endless, air permeable transport belt extending over a suction chamber and movable in a transport direction perpendicular a scanning direction of the printhead carriage.

12. The printer according to claim 11, wherein the hold-down body extends in the transport direction along the printing assembly.

13. The printer according to claim 12, wherein the curvature adjuster is arranged to adjust a tension in the hold-down body, wherein the tension determines the hold down force, and wherein the hold down force extends in the vertical direction.

14. The printer according to claim 13, wherein the curvature adjuster is positioned remote from the printing assembly in the transport direction.

15. The printer according to claim 13, wherein the curvature adjuster extends between a path of the inkjet printhead carriage and the transport belt.

16. A method for printing on a print medium on the printer according to claim 10, comprising:
selecting a print medium;
curving the hold-down body into a predetermined curvature in correspondence to the selected print medium, so that a portion of the hold-down body presses onto the print medium and/or a medium support surface facing a printing assembly; and
transporting a print medium on the medium support surface, so that at least one of its edges is forced under the hold-down body.
